(19) United States
(12) Patent Application Publication
(10) Pub. No.: US 2025/0344109 A1
(43) Pub. Date: Nov. 6, 2025

(54) MULTICAST SERVICE PROCESSING METHOD AND APPARATUS, TERMINAL, NETWORK SIDE DEVICE, AND STORAGE MEDIUM

(71) Applicant: VIVO MOBILE COMMUNICATION CO., LTD., Dongguan (CN)

(72) Inventor: Jiamin LIU, Dongguan (CN)

(21) Appl. No.: 19/271,804

(22) Filed: Jul. 17, 2025

Related U.S. Application Data
(63) Continuation of application No. PCT/CN2024/072598, filed on Jan. 16, 2024.

(30) Foreign Application Priority Data
Jan. 18, 2023 (CN) 202310076804.9

(51) Int. Cl. H04W 36/00; H04W 68/02; H04W 76/27

(52) U.S. Cl. CPC H04W 36/0007; H04W 68/02; H04W 76/27

(57) ABSTRACT

This application discloses a multicast service processing method and apparatus, a terminal, a network side device, and a storage medium, and belongs to the field of communication technologies. The multicast service processing method in embodiments of this application includes: receiving, by a terminal, a first message from a network side device in a non-connected state, where the first message is used to indicate a first service state of a target multicast service or to indicate the terminal whether to perform first state conversion; and executing, by the terminal, a target behavior according to the first message; where the first service state includes an active state or an inactive state; the first state conversion includes conversion from a non-connected state to a connected state; and the target multicast service is a multicast service that the terminal has joined.

### CROSS-REFERENCE TO RELATED APPLICATIONS

This application is a continuation of International Patent Application No. PCT/CN2024/072598, filed on Jan. 16, 2024, which claims the priority of Chinese Patent Application No. 202310076804.9, filed in China on Jan. 18, 2023, both of which are incorporated herein by reference in their entireties.

### TECHNICAL FIELD

This application belongs to the field of communication technology, and specifically, relates to a multicast service processing method and apparatus, a terminal, a network side device, and a storage medium.

### BACKGROUND

In a communication system, multicast services gradually increase, and have a wider application range. For example, the multicast services may be applied to scenarios such as public safety and software delivery.

### SUMMARY

Embodiments of this application provide a multicast service processing method and apparatus, a terminal, a network side device, and a storage medium, so as to reduce network control and management overheads while ensuring a multicast service data receiving effect, thereby helping improve overall network efficiency.

According to a first aspect, a multicast service processing method is provided, including:
receiving, by a terminal, a first message from a network side device in a non-connected state, where the first message is used to indicate a first service state of a target multicast service or to indicate the terminal whether to perform first state conversion; and
executing, by the terminal, a target behavior according to the first message;
where the first service state includes an active state or an inactive state;
the first state conversion includes conversion from a non-connected state to a connected state; and
the target multicast service is a multicast service that the terminal has joined.

According to a second aspect, a multicast service processing apparatus is provided, including:
a receiving module, configured to receive a first message from a network side device in a non-connected state, where the first message is used to indicate a first service state of a target multicast service or to indicate the terminal whether to perform first state conversion; and
an execution module, configured to execute a target behavior according to the first message;
where the first service state includes an active state or an inactive state;
the first state conversion includes conversion from a non-connected state to a connected state; and
the target multicast service is a multicast service that the terminal has joined.

According to a third aspect, a multicast service processing method is provided, including:
sending, by a network side device, a first message to a first terminal in a non-connected state, where the first message is used to indicate a first service state of a target multicast service or indicate the first terminal whether to perform first state conversion;
where the first service state includes an active state or an inactive state;
the first state conversion includes conversion from a non-connected state to a connected state; and
the target multicast service is a multicast service that the first terminal has joined.

According to a fourth aspect, a multicast service processing apparatus is provided, including:
a sending module, configured to send a first message to a first terminal in a non-connected state, where the first message is used to indicate a first service state of a target multicast service or indicate the first terminal whether to perform first state conversion;
where the first service state includes an active state or an inactive state;
the first state conversion includes conversion from a non-connected state to a connected state; and
the target multicast service is a multicast service that the first terminal has joined.

According to a fifth aspect, a terminal is provided, including a processor and a memory, the memory stores a program or instructions capable of running on the processor, and the program or the instructions are executed by the processor, the steps of the multicast service processing method according to the first aspect are implemented.

According to a sixth aspect, a network side device is provided, including a processor and a memory. The memory stores a program or instructions capable of running on the processor. When the program or the instructions are executed by the processor, the steps of the multicast service processing method according to the third aspect are implemented.

According to a seventh aspect, a communication system is provided, including: a terminal and a network side device, where the terminal may be configured to perform the steps of the multicast service processing method according to the first aspect, and the network side device may be configured to perform the steps of the multicast service processing method according to the third aspect.

According to an eighth aspect, a readable storage medium is provided. The readable storage medium stores a program or instructions. The program or instructions, when executed by a processor, implement the steps of the multicast service processing method according to the first aspect, or implement the steps of the multicast service processing method according to the third aspect.

According to a ninth aspect, a computer program/program product is provided, where the computer program/program product is stored in a storage medium, and the computer program/program product is executed by at least one processor to implement the steps of the multicast service processing method according to the first aspect, or implement the steps of the multicast service processing method according to the third aspect.

In embodiments of this application, a terminal receives a first message from a network side device in a non-connected state. The first message is used to indicate a first service state of a target multicast service or indicate the terminal whether to perform first state conversion. The first service state includes an active state or an inactive state. The terminal executes a target behavior according to the first message. A network side device indicates, by using the first message, the first service state of the target multicast service to the terminal or indicate the terminal whether to perform first state conversion.

### BRIEF DESCRIPTION OF THE DRAWINGS

FIG. 1 is a block diagram of a wireless communication system to which an embodiment of this application can be applied;

FIG. 2 is an implementation flowchart of a multicast service processing method according to an embodiment of this application;

FIG. 3 is a schematic structural diagram of a multicast service processing apparatus corresponding to FIG. 2;

FIG. 4 is an implementation flowchart of another multicast service processing method according to an embodiment of this application;

FIG. 5 is a schematic structural diagram of a multicast service processing apparatus corresponding to FIG. 4;

FIG. 6 is a schematic structural diagram of a terminal according to an embodiment of this application; and

FIG. 7 is a schematic structural diagram of a network side device according to an embodiment of this application.

### DETAILED DESCRIPTION

The following clearly describes the technical solutions in embodiments of this application with reference to the accompanying drawings in the embodiments of this application. Clearly, the described embodiments are some but not all of the embodiments of this application. All other embodiments obtained by a person of ordinary skill in the art based on the embodiments of this application shall fall within the protection scope of this application.

In the specification and claims of this application, the terms “first” and “second” are used to distinguish between similar objects, but are unnecessarily used to describe a specific sequence or order. It should be understood that the terms in such a way are exchangeable in a proper case, so that the embodiments of this application described herein can be implemented in an order other than the order shown or described herein. In addition, objects distinguished by “first”, “second”, and the like are generally of one type, and a quantity of objects is not limited. For example, there may be one or more first objects. In addition, “or” in the specification and claims represents at least one of connected objects. For example, “A or B” covers three solutions, that is, solution 1: including A and excluding B. Solution 2: including B and excluding A. Solution 3: including both A and B.

It should be noted that technologies described in embodiments of this application are not limited to a Long Term Evolution (Long Term Evolution, LTE)/LTE-Advanced (LTE-Advanced, LTE-A) system, and may be further applied to another wireless communication system such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), Single-carrier Frequency Division Multiple Access (Single-carrier Frequency Division Multiple Access, SC-LTE-A), and another system. The terms “system” and “network” in the embodiments of this application are often used interchangeably. The described technology may be used in the foregoing system and radio technology, or may be used in another system and radio technology. The following description describes a New Radio (New Radio, NR) system for example, and the NR term is used in most of the following descriptions. However, these technologies may also be applied to applications other than NR system applications, such as a 6th Generation (6th Generation, 6G) communication system.

FIG. 1 is a block diagram of a wireless communication system applicable to an embodiment of this application. The wireless communication system includes a terminal 11 and a network side device 12.

The terminal 11 may be a terminal-side device such as a mobile phone, a tablet personal computer (Tablet Personal Computer), a laptop computer (Laptop Computer), or referred to as a notebook computer, a personal digital assistant (Personal Digital Assistant, PDA), a palmtop computer, a netbook, an ultra-mobile personal computer (ultra-mobile personal computer, UMPC), a mobile Internet device (Mobile Internet Device, MID), an augmented reality (augmented reality, AR)/virtual reality (virtual reality, VR) device, a robot, a wearable device (Wearable Device), a vehicular user equipment (VUE), a pedestrian user equipment (PUE), a smart home (a home device with a wireless communication function, such as a refrigerator, a television, a washing machine, or furniture), a game machine, a personal computer (personal computer, PC), a teller machine, or a self-service device. The wearable device includes: a smart watch, a smart band, a smart headset, smart glasses, smart jewelry (a smart wristlet, a smart bracelet, a smart ring, a smart necklace, a smart leglet, a smart anklet, and the like), a smart wrist strap, a smart dress, and the like. It should be noted that a specific type of the terminal 11 is not limited in embodiments of this application.

The network side device 12 may include an access network device. The access network device may also be referred to as a radio access network device, a radio access network (Radio Access Network, RAN), a radio access network function, or a radio access network unit. The access network device may include a base station, a WLAN access point, a Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another suitable term in the art. Provided that a same technical effect is achieved, the base station is not limited to a specific technical term. It should be noted that in embodiments of this application, only a base station in an NR system is used as an example for description, and a specific type of the base station is not limited.

For ease of understanding, related technologies and concepts in embodiments of this application are first described.

During broadcast multicast transmission of LTE, a multicast broadcast single frequency network (Multicast Broadcast Single Frequency Network, MBSFN) manner is supported to send a multimedia broadcast multicast service (Multimedia Broadcast Multicast Service, MBMS) and a single cell point to multipoint (Single cell Point to Multipoint, sc-ptm) manner is supported to send a multicast service.

In the MBSFN manner, cells located in a same MBSFN area synchronously send a same broadcast service, to facilitate reception by a terminal. Control information, such as a control channel parameter, a service channel parameter, and scheduling information, and data information of the MBMS service are all sent in a broadcast manner, so that both a terminal in an idle (IDLE) state and a terminal in a connected state (CONNECTED) can receive the MBMS service.

The sc-ptm is a multicast sending manner standardized after the MBSFN, and a largest difference from the MBSFN manner is that sending scheduling is performed in only a single cell, and service scheduling is performed by using a group radio network temporary identity (group Radio Network Temporary Identity, g-RNTI). A control channel parameter, a service identifier, period information, and the like are broadcast in a broadcast message. Scheduling information is notified by using a physical downlink control channel (Physical Downlink Control Channel, PDCCH) scrambled by the g-RNTI. A data part is sent in a multicast manner, which means that an interested terminal monitors the g-RNTI to obtain data scheduling and further perform receiving.

In an existing NR system, a broadcast (broadcast) service is configured and notified in a multicast control channel (MultiCast Control Channel, MCCH) manner, which can satisfy a need of a terminal in any radio resource control (Radio Resource Control, RC) state (for example, an RRC connected/idle/inactive (CONNECTED/IDLE/INACTIVE) state) to receive a service. The broadcast service does not involve an activate/deactivate operation. When a service configuration starts to appear in the MCCH, it means that receiving may start, and when the service configuration is removed from the MCCH, it means that the service ends, and receiving is stopped.

An NR multicast (multicast) service only supports a terminal in an RRC CONNECTED state, and dedicated signaling is used to send service configuration information to the terminal. Different from the broadcast service only in a start/stop (start/stop) state, the multicast service also has an activation/inactivation (activation/deactivation) state, used for temporary interruption and recovery of service data. Because all terminals receiving the multicast service need to remain in a connected state, when the multicast service is temporarily inactive, the network side device may release the terminal to an inactive/idle state, and when the multicast service is activated, the terminal is invoked back to a connected state by using a paging message to continue receiving.

The foregoing describes related technologies and concepts involved in embodiments of this application. With reference to the accompanying drawings, the following describes in detail the multicast service processing method provided in embodiments of this application by using some embodiments and application scenarios thereof.

The technical solutions provided in embodiments of this application may be applied to various scenarios such as public safety, Internet of Things (Internet of Things, IoT) applications, software delivery, interactive network television (IPTV), and livestreaming shopping.

Because a large quantity of terminals interested in a multicast service are kept in a connected state, network control and management overheads are large, and overall network efficiency is not high. Therefore, it needs to be considered that a terminal is released to an inactive state to receive data of the multicast service. However, because the multicast service may have multiple service states, it further needs to be considered that the terminal is notified of an update of a service state of the multicast service. Embodiments of this application provide an explicit solution on how to obtain related information of the multicast service in time by a terminal in a non-connected state. A network side device indicates, by using the first message, the first service state of the target multicast service to the terminal or indicate the terminal whether to perform first state conversion. In this way, the terminal can obtain related information of the target multicast service in time in a non-connected state, and execute a corresponding behavior in time without the need of the terminal to be always in a connected state to monitor a multicast service and receive multicast service data. Network control and management overheads can be reduced while a receiving effect of the multicast service data is ensured, helping improve overall network efficiency.

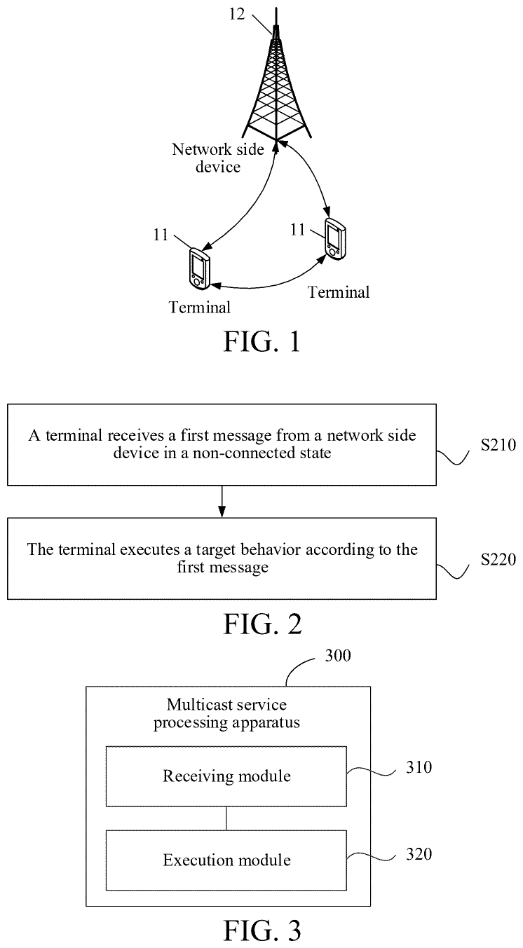

FIG. 2 is an implementation flowchart of a multicast service processing method according to an embodiment of this application. The method may include the following steps:

S210: A terminal receives a first message from a network side device in a non-connected state.

The first message is used to indicate a first service state of a target multicast service or indicate the terminal whether to perform first state conversion. The first service state includes an active state or an inactive state, and first state conversion includes conversion from a non-connected state to a connected state. The non-connected state may include an idle state or an inactive state. The target multicast service is a multicast service that the terminal has joined (joined). The multicast service that the terminal has joined is a multicast service that the terminal is interested and has joined.

The network side device may send the first message to the first terminal in a non-connected state according to the first service state of the target multicast service or other related information, such as whether the target multicast service supports data receiving by a terminal in a non-connected state. The first message is used to indicate a first service state of a target multicast service or to indicate the terminal whether to perform first state conversion. The first message may be used to indicate a first service state of one or more multicast services, and the target multicast service is any one of the one or more multicast services.

After receiving the first message from the network side device in a non-connected state, the terminal may continue to perform operations of subsequent steps. The terminal herein may be any one of first terminals in a non-connected state.

The terminal may be the terminal 11 in FIG. 1, and the network side device may be the network side device 12 in FIG. 1.

S220: The terminal executes a target behavior according to the first message.

After receiving the first message from the network side device in a non-connected state, the terminal may determine, according to the first message, the first service state of the target multicast service or determine whether the network side device indicates to perform first state conversion. The terminal may execute the target behavior according to the first message. Optionally, the target behavior may include conversion from a non-connected state to a connected state, or remaining in a non-connected state. Optionally, the target behavior may include monitoring the target multicast service in a non-connected state and receiving data of the target multicast service.

By applying the method provided in this embodiment of this application, a terminal receives a first message from a network side device in a non-connected state. The first message is used to indicate a first service state of a target multicast service or indicate the terminal whether to perform first state conversion. The first service state includes an active state or an inactive state. The terminal executes a target behavior according to the first message. A network side device indicates, by using the first message, the first service state of the target multicast service to the terminal or indicate the terminal whether to perform first state conversion. In this way, the terminal can obtain related information of the target multicast service in time in a non-connected state, and execute a corresponding behavior in time without the need of the terminal to be always in a connected state to monitor a multicast service and receive multicast service data. Network control and management overheads can be reduced while a receiving effect of the multicast service data is ensured, helping improve overall network efficiency.

In some embodiments of this application, the first message may include a first paging message, and the first paging message includes a service identifier of the target multicast service. The multicast service processing method may further include the following step:

The terminal determines that the first service state of the target multicast service is the active state according to the service identifier of the target multicast service in the first paging message.

In some embodiments of this application, that the terminal executes a target behavior according to the first message includes:

The terminal executes the target behavior according to a capability of the terminal. For ease of description, the foregoing two steps are combined for description.

In this embodiment of this application, the first message may include the first paging message, and the first paging message includes a service identifier of the target multicast service, such as a temporary mobile group identity (Temporary Mobile Group Identity, TMGI). A message format of the first paging message may be a group paging message format, for example, a group paging message of an R17 format, that is, a paging message carrying a TMGI.

For any multicast service, if the first paging message includes a service identifier of the multicast service, it may be considered that the multicast service is in an active state, data of the multicast service is continuously arrived and delivered, and the terminal needs to remain in a monitoring state to receive the data of the multicast service at any time.

The terminal may determine, according to the service identifier of the target multicast service in the first paging message, that the first service state of the target multicast service is the active state, that is, the target multicast service is currently in an active period.

The terminal needs to monitor the target multicast service and receive data of the target multicast service. The terminal may execute the target behavior according to a capability of the terminal.

The terminal can be enabled by using the first paging message to execute in time the target behavior for the target multicast service that the terminal is interested and that has joined.

In some embodiments of this application, the terminal does not have a capability of receiving multicast service data in a non-connected state, and the target behavior includes converting from a non-connected state to a connected state.

Different terminals may have different terminal capabilities. For example, an R17 terminal does not have a capability of receiving multicast service data in a non-connected state, some R18 terminals do not have a capability of receiving multicast service data in a non-connected state, and some R18 terminals have a capability of receiving multicast service data in a non-connected state.

If the terminal does not have a capability of receiving data of the multicast service in a non-connected state, after receiving the first paging message, and determining that the target multicast service is in the active state, the terminal may convert from a non-connected state to a connected state to monitor the target multicast service in a connected state, and receive the data of the target multicast service. In this way, the terminal can receive the data of the target multicast service in time, thereby ensuring a data receiving effect.

In some embodiments of this application, that the terminal executes the target behavior according to a capability of the terminal may include the following step:

In a case that the terminal has a capability of receiving multicast service data in a non-connected state, the terminal executes the target behavior if it is determined that the terminal has valid configuration information of the target multicast service, or it is determined that the target multicast service supports data receiving by a terminal in a non-connected state; and
the target behavior includes at least one of the following content:
monitoring the target multicast service;
receiving data of the target multicast service; and
remaining in a non-connected state.

In this embodiment of this application, if the terminal has a capability of receiving multicast service data in the non-connected state, the terminal may receive the multicast service data in a non-connected state. After receiving the first paging message and determining that the target multicast service is in the active state, the terminal may further determine whether the terminal has valid configuration information of the target multicast service. For example, if the terminal may read the configuration information of the target multicast service in an MCCH message, and the configuration information is latest valid configuration information, it may be considered that the terminal has the valid configuration information of the target multicast service. Alternatively, the terminal may determine, according to another indication or configuration of the network side device or a protocol agreement, whether the target multicast service supports data receiving by a terminal in a non-connected state.

In a case that the terminal determines that the terminal has the valid configuration information of the target multicast service, or determines that the target multicast service supports data receiving by a terminal in a non-connected state, the terminal may execute the target behavior. The target behavior includes at least one of monitoring the target multicast service, receiving data of the target multicast service, and remaining in a non-connected state. Optionally, the terminal may monitor and receive the data of the target multicast service continuously or according to a discontinuous reception (Discontinuous Reception, DRX) pattern (pattern).

In a case that a terminal having a capability of receiving multicast service data in a non-connected state determines that the terminal has the valid configuration information of the target multicast service, or determines that the target multicast service supports data receiving by a terminal in a non-connected state, the terminal can monitor and receive data of the target multicast service in a non-connected state without converting to the connected state. This can reduce control and management overheads on the network side device, helping improve overall network efficiency.

In a case that a terminal having a capability of receiving multicast service data in a non-connected state determines that the terminal does not have the valid configuration information of the target multicast service, or determines that the target multicast service does not support data receiving by a terminal in a non-connected state, the terminal may execute the target behavior, where the target behavior includes converting from a non-connected state to a connected state. That is, the terminal needs to monitor and receive data of the target multicast service after converting from a non-connected state to a connected state, so that the terminal can receive multicast service data in time, thereby ensuring a data receiving effect.

Certainly, the first paging message may further include more content. Optionally, the first paging message may further include information used to indicate the first service state of the target multicast service. It is clearly indicated by using the information that the target multicast service is in the active state or the inactive state.

In some embodiments of this application, the first message may include a first multicast control channel message. The multicast service processing method may further include the following step:

The terminal determines that the first service state of the target multicast service is the active state or the inactive state according to the first multicast control channel message.

In some embodiments of this application, that the terminal executes a target behavior according to the first message includes:

The terminal executes the target behavior according to the first service state. For ease of description, the foregoing two steps are combined for description.

In this embodiment of this application, the first message may include a first multicast control channel message, such as an MCCH message. The first multicast control channel message is used to indicate a first service state of the target multicast service. After receiving the first multicast control channel message, the terminal may first determine the first service state of the target multicast service, that is, determine whether the target multicast service is in an active state or an inactive state. The terminal may execute the target behavior according to the active state or the inactive state of the target multicast service.

The terminal may be enabled, by using the first multicast control channel message, to obtain the first service state of the target multicast service in time, and execute the target behavior in time.

In some embodiments of this application, if the target multicast service is in the active state, the target behavior may include monitoring the target multicast service, or receiving data of the target multicast service.

Alternatively, if the target multicast service is in the inactive state, the target behavior may include stopping monitoring the target multicast service, or stopping receiving data of the target multicast service.

For any multicast service, if the multicast service is in an active state, it means that the multicast service is in an active period, data of the multicast service is continuously arrived and delivered, and a corresponding terminal needs to remain in a monitoring state to receive the data of the multicast service at any time. If the multicast service is in an inactive state, it means that the multicast service is in an inactive period, the multicast service does not need to be monitored, and no data is delivered temporarily, and the corresponding terminal may perform a power saving operation until the multicast service is activated again.

If the terminal determines, according to the first multicast control channel message, that the first service state of the target multicast service is the active state, the terminal may monitor the target multicast service, or receive data of the target multicast service. In addition, if the terminal has a capability of receiving multicast service data in a non-connected state, the terminal may remain in the non-connected state to monitor the target multicast service, or receive the data of the target multicast service. If the terminal does not have a capability of receiving multicast service data in the non-connected state, the terminal may monitor the target multicast service or receive the data of the target multicast service after converting from the non-connected state to the connected state.

If the terminal determines, according to the first multicast control channel message, that the first service state of the target multicast service is the inactive state, the terminal may stop monitoring the target multicast service, or stop receiving the data of the target multicast service. In addition, the terminal may continue remaining in the non-connected state.

The terminal may accurately obtain the first service state of the target multicast service according to the first multicast control channel message, so as to monitor the target multicast service or receive the data of the target multicast service when the target multicast service is in the active state, so that the terminal can receive the data of the target multicast service in time. When the target multicast service is in the inactive state, the terminal stops monitoring the target multicast service or stops receiving the data of the target multicast service, so that the terminal can use a power saving operation and reduce energy consumption.

In this embodiment of this application, indication information of the active state/the inactive state of the multicast service may be carried in the MCCH message. The MCCH message periodically and repeatedly sends configuration information of a broadcast service or a multicast service. An MCCH of the broadcast service and an MCCH of the multicast service may be reused or independent. Different multicast services may be carried in different MCCH signaling or channels. In any case, configuration information of a multicast service supporting data receiving by a terminal in a non-connected state is carried in one MCCH. Different configuration information of different multicast services may be provided in the MCCH message based on the TMGI. Therefore, an indication manner about the active state or the inactive state of the multicast service may be separately provided in the MCCH message based on the TMGI.

Optionally, configuration information corresponding to the target multicast service in the first multicast control channel message includes a first indication field, the first indication field includes a first value or a second value, the first value is used to indicate that the target multicast service is in the active state, and the second value is used to indicate that the target multicast service is in the inactive state.

That is, the first indication field is introduced to configuration information corresponding to each multicast service and carried in the first multicast control channel message. The first indication field may be a binary bit. The target multicast service is any one of the multicast services, and the configuration information corresponding to the target multicast service includes the first indication field. The first indication field includes a first value or a second value, the first value is used to indicate that the target multicast service is in the active state, and the second value is used to indicate that the target multicast service is in the inactive state. For example, the first value is 0, and the second value is 1. That is, in the configuration information corresponding to the target multicast service, when the value of the first indication field is 0, it indicates that the target multicast service is in the active state, and when the value of the first indication field is 1, it indicates that the target multicast service is in the inactive state. Similarly, the first value is 1, and the second value is 0. That is, in the configuration information corresponding to the target multicast service, when the value of the first indication field is 1, it indicates that the target multicast service is in the active state, and when the value of the first indication field is 0, it indicates that the target multicast service is in the inactive state.

Optionally, the terminal determines, in a case that the configuration information corresponding to the target multicast service in the first multicast control channel message includes the second indication field, that the target multicast service is in a first state, where the first state is the active state or the inactive state; or
the terminal determines, in a case that the configuration information corresponding to the target multicast service in the first multicast control channel message does not include the second indication field, that the target multicast service is in a second state, where the second state is the inactive state or the active state; and
the first state is different from the second state.

That is, the second indication field is introduced to the configuration information corresponding to each multicast service and carried in the first multicast control channel message. The second indication field is an optional field, for example, a Boolean field. The target multicast service is any one of the multicast services, and whether the target multicast service is in the active state or the inactive state is indicated by using whether the second indication field appears. If configuration information corresponding to the target multicast service in the first multicast control channel message includes the second indication field, it indicates that the target multicast service is in a first state, where the first state is the active state or the inactive state; or if configuration information corresponding to the target multicast service in the first multicast control channel message does not include the second indication field, the target multicast service is in a second state, where the second state is the inactive state or the active state.

When the configuration information corresponding to the target multicast service in the first multicast control channel message includes the second indication field, the terminal may determine that the target multicast service is in the first state, for example, determine that the target multicast service is in the active state, or determine that the target multicast service is in the inactive state. In a case that the configuration information corresponding to the target multicast service in the first multicast control channel message does not include the second indication field, the terminal may determine that the target multicast service is in the second state, for example, determine that the target multicast service is in the inactive state, or determine that the target multicast service is in the active state. The first state is different from the second state. For example, the first state is the active state, and the second state is the inactive state. That is, in the configuration information corresponding to the target multicast service, when the second indication field appears, it indicates that the target multicast service is in the active state, and when the second indication field does not appear, it indicates that the target multicast service is in the inactive state. Similarly, the first state is the inactive state, and the second state is the active state. That is, in the configuration information corresponding to the target multicast service, when the second indication field does not appear, it indicates that the target multicast service is in the active state, and when the second indication field appears, it indicates that the target multicast service is in the inactive state.

Optionally, configuration information corresponding to the target multicast service in the first multicast control channel message includes a third indication field and a fourth indication field, the third indication field is used to indicate whether the target multicast service is in the active state, and the fourth indication field is used to indicate whether the target multicast service is in the inactive state.

That is, the third indication field and the fourth indication field are introduced to the configuration information corresponding to each multicast service and carried in the first multicast control channel message. The third indication field or the fourth indication field may be a binary bit, and indicates, by using a first value or a second value, that the target multicast service is in the active state or the inactive state. The third indication field or the fourth indication field may alternatively be a field that optionally appears, for example, a Boolean field, and indicates, by using whether the target multicast service appears, that the target multicast service is in the active state or the inactive state. The target multicast service is any one of the multicast services, and the configuration information corresponding to the target multicast service includes the third indication field and the fourth indication field. The third indication field is used to indicate that the target multicast service is in the active state, and the fourth indication field is used to indicate that the target multicast service is in the inactive state.

The foregoing describes multiple manners in which the first multicast control channel message is used to indicate that the target multicast service is in the active state or the inactive state. The first multicast control channel message is used to indicate that the target multicast service is in the active state or the inactive state, so that the terminal can obtain the service state of the target multicast service in time, and further execute the target behavior in time.

For ease of understanding, corresponding processing behaviors of the multicast service being in the active state and the inactive state and related consideration are described below by using specific examples.

A difference between a multicast service and a broadcast service lies in that in addition to starting and ending, the multicast service also has an active/inactive state. As described above, the active state means that the multicast service is in an active period, multicast service data is continuously arrived and delivered, and the terminal needs to remain in a monitoring state to receive the multicast service data at any time. The inactive state means that the multicast service is temporarily in an inactive period, that is, after inactivation, the multicast service does not need to be monitored, and no multicast service data is delivered temporarily, and the terminal may perform a power saving operation until the multicast service is activated again.

For a terminal in an inactive state to receive a multicast service, it is considered that service configuration information is also sent in a manner similar to that of the broadcast service. However, because the broadcast service does not require a change of an active/inactivate state, the original MCCH design does not support the indication, and an enhanced manner needs to be considered for the multicast service. There is at least one of the following manners:

Manner 1: A terminal in an inactive state is notified of an active/inactive state of a multicast service by using a paging message.

Because a paging message for the multicast service has been introduced to R17, a network side device may carry a service identifier of the multicast service, for example, a TMGI, in the paging message. All related terminals receiving the paging message immediately enter an RRC connected state, and prepare to receive multicast service data.

For such an already existing paging message in R17, an R18 terminal needs to have new interpretation because R18 allows the terminal to receive multicast service data in an inactive state. Therefore, when an R18 terminal in the inactive state can obtain valid configuration information of a multicast service, for example, there is the configuration information of the multicast service in an MCCH, latest valid configuration information can be read. It should be understood that when the terminal in the inactive state of R18 receives a group paging message (that is, a paging message carrying a TMGI) of the R17 format, the multicast service identified by the TMGI is in an active state, and the R18 terminal can monitor the multicast service and receive the multicast service data continuously or according to a DRX manner.

The paging message may further carry more content, for example, an indication that explicitly indicates that a multicast service of a TMGI is really in an active state, or that a multicast service added with the TMGI is in an inactive state.

Manner 2: An indication of an active/inactive state of a multicast service is carried in an MCCH message. As described above, the MCCH message periodically and repeatedly sends configuration information of a broadcast service or a multicast service. An MCCH of the broadcast service and an MCCH of the multicast service may be reused or independent. Different multicast services may be carried in different MCCH signaling or channels. In any case, configuration information of a multicast service supporting data receiving by a terminal in a non-connected state is carried in one MCCH. Different configuration information of different multicast services may be provided in the MCCH message based on the TMGI. Therefore, an indication manner about the active state or the inactive state of the multicast service may be separately provided in the MCCH message based on the TMGI.
1) One binary bit may be introduced into configuration information corresponding to each TMGI. A value of the bit being 0 represents an inactive state, and the value of the bit being 1 represents an active state.
2) An optional field, for example, a Boolean field, is introduced into configuration information corresponding to each TMGI. Once the field appears, it indicates an active state, and if the field does not appear, it indicates an inactive state, or vice versa.
3) Two indication fields are introduced to configuration information corresponding to each TMGI, where the two indication fields are respectively used to indicate whether the multicast service is an active state and whether it is an inactive state.

It should be noted that in the foregoing paging manner and MCCH manner, because a paging message reuses a format of R17 and may be used as an indication of an active state, and it is very convenient for the MCCH to add an indication field about an active/inactive state to configuration information corresponding to a TMGI. Therefore, the MCCH manner may be applied to a scenario of indication of an active/inactive state of a multicast service of an inactive terminal in R18. In an application, the two manners may be combined for indication.

For the terminal, when the terminal receives the foregoing indication information from the network side device, behaviors of the terminal are as follows:

First, for an R17 terminal, because the R17 terminal can only receive and parse an R17 group paging format message, a behavior thereof is the same as a behavior in the related technology. When a paging message includes a multicast service that the terminal is interested and has joined, the terminal immediately enters a connected state.

Second, for an R18 inactive terminal, if a received paging message includes a multicast service that the terminal is interested and that has joined, and a message format of the paging message belongs to the R17 group paging message format, the following two cases may exist:
1) An R18 terminal in an inactive state determines that the R18 terminal in an inactive state has latest all configuration information of the target multicast service, for example, the R18 terminal in an inactive state may or has read all configurations of the target multicast service in the MCCH, and the configurations are currently valid, or the network side device indicates in another explicit manner that the target multicast service currently supports receiving by a terminal in an inactive state, so that the R18 terminal in an inactive state may understand the paging message as that the target multicast service corresponding to the TMGI identifier is in an active state, only need to start to monitor the target multicast service and receive data of the target multicast service, and does not need to immediately perform state conversion to enter an RRC connected state.
2) If an R18 terminal in an inactive state determines that the R18 terminal in an inactive state does not have all configuration information of the target multicast service received in the inactive state, for example, there is no configuration corresponding to the target multicast service in the MCCH, or the network side device indicates in another explicit manner that the target multicast service does not support receiving by a terminal in an inactive state currently, the R18 terminal in an inactive state should immediately perform state conversion to enter the RRC connected state, and the network side device controls a subsequent behavior, for example, obtain the configuration information of the target multicast service from the network side device and receive data of the target multicast service.

For an R18 terminal in an inactive state, when a received MCCH message includes a target multicast service that the R18 terminal in an inactive state is interested and has joined, if an indication field in the current MCCH indicates that the target multicast service is in an active state, the terminal monitors corresponding data scheduling and receives data; or if the indication field in the current MCCH indicates that the target multicast service is in an inactive state, the terminal stops monitoring corresponding data scheduling and receiving the data.

For an R18 terminal in an inactive state, if a current MCCH message includes configuration information of a target multicast service that the current MCCH message is interested and has joined, the terminal needs to monitor a change notification of the MCCH according to the configuration information; when finding that the MCCH changes, the terminal immediately reads content of the MCCH, finds the configuration information of the target multicast service that the terminal is interested, and reads an active/inactive state indication; and if the indication changes to an active state, the terminal starts to monitor corresponding data scheduling and receives data immediately or starting from an agreed starting moment (for example, a starting location of a next period); and if an indication field in the current MCCH indicates that the service state of the target multicast service changes to the inactive state, the terminal stops monitoring corresponding data scheduling and receiving the data.

For an R18 terminal in idle state or connected state, if the terminal can read configuration information of a target multicast service that the terminal is interested by using an MCCH, the terminal may also obtain an indication of an active/inactive state, obtain change information of the indication of the active/inactive state by using an MCCH change indication, and further read the indication again, and start or stop scheduling monitoring and data receiving of a related multicast service according to the indication.

The technical solution provided in embodiments of this application is described above from a perspective of indication of an active/inactive state of a multicast service. The following describes the technical solution from a perspective of requiring a terminal to perform state conversion.

In some embodiments of this application, the first message may include a second multicast control channel message, and that the terminal executes a target behavior according to the first message may include the following steps:
Step 1: The terminal determines whether to perform first state conversion according to the second multicast control channel message.
Step 2: The terminal executes the target behavior in a case that it is determined to perform first state conversion, where the target behavior includes conversion from a non-connected state to a connected state.

For ease of description, the foregoing two steps are combined for description.

In this embodiment of this application, the network side device may determine, according to an actual situation, whether to indicate a terminal in a non-connected state to perform first state conversion. For example, when a network congestion status is relieved, or service receiving quality of service (Quality of Service, QoS) of a terminal in a non-connected state cannot satisfy a requirement, it may be determined that the terminal in a non-connected state needs to be indicated to perform first state conversion. The network side device may send a first message to the terminal in a non-connected state. The first message may include a second multicast control channel message, such as an MCCH message, used for indicating the terminal to perform first state conversion. Optionally, the terminal may be indicated to perform first state conversion by using configuration information corresponding to the target multicast service and in the second multicast control channel message.

After receiving the second multicast control channel message, the terminal in a non-connected state may determine whether to perform first state conversion according to the second multicast control channel message.

In a case that the terminal determines to perform first state conversion, the executed target behavior includes converting from a non-connected state to a connected state. In this way, the terminal can convert to the connected state in time to monitor the target multicast service and receive the data of the target multicast service.

In some embodiments of this application, configuration information corresponding to the target multicast service in the second multicast control channel message includes a fifth indication field, and the fifth indication field is used to indicate whether the target multicast service supports data receiving by a terminal in a non-connected state, or indicate whether a terminal in a non-connected state receiving data of the target multicast service is required to enter a connected state.

Optionally, the fifth indication field may be a binary bit. A first value and a second value indicate whether the target multicast service supports data receiving by a terminal in a non-connected state, or indicate whether a terminal in a non-connected state receiving data of the target multicast service is required to enter a connected state.

Optionally, the fifth indication field may be a field that optionally appears. Whether the fifth indication field appears is used to indicate whether the target multicast service supports data receiving by a terminal in a non-connected state, or indicate whether a terminal in a non-connected state receiving data of the target multicast service is required to enter a connected state.

The terminal can accurately determine, according to the fifth indication field included in the configuration information corresponding to the target multicast service in the second multicast control channel message, whether the target multicast service supports data receiving by a terminal in a non-connected state, or whether the network side device requires the terminal to enter a connected state, and can further determine whether to perform first state conversion. For example, in a case that the target multicast service does not support data receiving by a terminal in a non-connected state, or the network side device requires a terminal in a non-connected state receiving the data of the target multicast service to enter a connected state, it is determined to perform first state conversion. Otherwise, in a case that the target multicast service supports data receiving by a terminal in a non-connected state, or the network side device does not require a terminal in a non-connected state receiving the data of the target multicast service to enter a connected state, it is determined not to perform first state conversion.

After the terminal determines to perform first state conversion, the executed target behavior may include conversion from a non-connected state to a connected state.

In some embodiments of this application, the configuration information corresponding to the target multicast service in the second multicast control channel message further includes a sixth indication field, and the sixth indication field is used to indicate restriction information of a terminal returning to a connected state or a terminal remaining in a non-connected state.

In this embodiment of this application, in addition to the fifth indication field being used for indicating whether the target multicast service supports data receiving by a terminal in a non-connected state, or indicating whether a terminal in a non-connected state receiving data of the target multicast service is required to be in a connected state, the configuration information corresponding to the target multicast service in the second multicast control channel message may further include a sixth indication field. The sixth indication field may be used to indicate restriction information of a terminal returning to a connected state or a terminal remaining in a non-connected state. Whether a terminal returns to a connected state or remains in a non-connected state may be preferably controlled by using the restriction information.

In some embodiments of this application, the restriction information may include a scale factor. That the terminal determines whether to perform first state conversion according to the second multicast control channel message may include the following step:

The terminal selects a random value within a first interval, and determines, according to a magnitude relationship between the random value and the scale factor, whether to perform first state conversion.

In this embodiment of this application, the sixth indication field included in the configuration information corresponding to the target multicast service in the second multicast control channel message is used to indicate restriction information of a terminal returning to a connected state or a terminal remaining in a non-connected state. The restriction information may be a scale factor. A configuration value of the scale factor may be 0, 10%, 20%, 35%, . . . , 90%, 100%, or the like. Each value indicates a proportion of terminals that the network side device expects to return to a connected state or remain in a non-connected state.

After receiving the second multicast control channel message in a non-connected state, the terminal may select a random value within the first interval, compare the random value with the scale factor, and determine, according to a magnitude relationship, whether to perform first state conversion. The first interval may be [0, 1].

Optionally, if the sixth indication field is used to indicate a scale factor of a terminal returning to a connected state, the terminal selects a random value within the first interval, and may determine to perform first state conversion when the random value is less than or equal to the scale factor.

For example, if the scale factor of a terminal returning to a connected state indicated by the sixth indication field is 50%, it indicates that the network side device expects 50% of terminals to return to a connected state. The terminal selects a random value within the first interval. If the random value is less than or equal to 50%, the terminal may determine to perform first state conversion; otherwise, the terminal remains in a non-connected state.

Optionally, if the sixth indication field is used to indicate a scale factor of a terminal remaining in a non-connected state, the terminal selects a random value within the first interval, and may determine to perform first state conversion when the random value is greater than or equal to the scale factor.

For example, if the scale factor of a terminal remaining in a non-connected state indicated by the sixth indication field is 30%, it indicates that the network side device expects 30% of terminals to remaining in a non-connected state. The terminal selects a random value within the first interval. If the random value is greater than or equal to 30%, the terminal may determine to perform first state conversion; otherwise, the terminal remains in a non-connected state.

It should be noted that when the scale factor is restriction information of a terminal returning to a connected state, the configuration value may be 0, or when the scale factor is restriction information of a terminal remaining in a non-connected state, the configuration value may be 100, representing that the network side device expects the terminal to remain in a non-connected state as much as possible to receive multicast service data, which may last for a length of several periods.

When a network load is relieved, the network side device may change the value by using an MCCH modification period. For example, the value is changed to 50%. Therefore, a terminal in a non-connected state that receives an MCCH message undergoes state conversion according to a probability of 50%, and enters a connected state.

The value of 50% usually lasts for only one MCCH modification period, that is, all terminals perform random number determining for only once, to ensure that state conversion is performed according to a scale factor set by the network side device. When a second MCCH modification period is reached, the network side device may reset the scale factor to 0 or 100, to ensure that remaining 50% terminals can remain in a non-connected state.

Certainly, subsequently, if the network load is continuously relieves, a specific proportion of terminals may be indicated again to perform state conversion.

If the network continues to be congested, a terminal in a connected state is released by using dedicated signaling to return to a non-connected state.

In some embodiments of this application, that the terminal determines whether to perform first state conversion according to the second multicast control channel message may include the following steps:

Step 1: The terminal determines, according to the second multicast control channel message, whether the second multicast control channel message includes configuration information corresponding to the target multicast service or whether included configuration information corresponding to the target multicast service is valid information.

Step 2: The terminal executes the target behavior in a case that the terminal determines that the second multicast control channel message does not include the configuration information corresponding to the target multicast service or the included configuration information corresponding to the target multicast service is invalid information.

For ease of description, the foregoing two steps are combined for description.

In this embodiment of this application, the terminal may be implicitly indicated to perform first state conversion by using the second multicast control channel message. When the network side device expects all terminals in a non-connected state to return to a connected state to continue receiving the data of the target multicast service, the network side device may delete the configuration information corresponding to the target multicast service from the second multicast control channel message or set the configuration information as invalid information. That is, the network side device may delete, in a case that the network side device determines to indicate the first terminal to perform first state conversion, configuration information corresponding to the target multicast service from the second multicast control channel message, or set configuration information corresponding to the target multicast service and included in the second multicast control channel message as invalid information.

The terminal receives the second multicast control channel message in a non-connected state, and may determine, according to the second multicast control channel message, whether the second multicast control channel message includes configuration information corresponding to the target multicast service or whether included configuration information corresponding to the target multicast service is valid information.

If the second multicast control channel message does not include the configuration information of the target multicast service, or the configuration information of the target multicast service included in the second multicast control channel message is invalid information, the terminal may determine to perform first state conversion to convert from a non-connected state to a connected state to monitor the target multicast service and receive the data of the target multicast service.

If the second multicast control channel message includes the configuration information of the target multicast service, or the configuration information of the target multicast service included in the second multicast control channel message is valid information, the terminal may determine not to perform first state conversion, and continue remaining in a non-connected state to monitor the target multicast service and receive the data of the target multicast service.

Implicitly indicating, by using the second multicast control channel message, the terminal whether to perform first state conversion helps the terminal accurately determine whether to perform first state conversion, so that the terminal can convert from a non-connected state to a connected state in time when it is determined to perform first state conversion, thereby ensuring a data receiving effect.

In some embodiments of this application, the first message carries a multicast service list, each multicast service in the multicast service list supports data receiving by a terminal in a non-connected state, or each multicast service having a valid flag bit in the multicast service list supports data receiving by a terminal in a non-connected state, and that the terminal executes a target behavior according to the first message may include the following steps:

Step 1: The terminal determines, according to the multicast service list, whether the target multicast service supports data receiving by a terminal in a non-connected state.

Step 2: The terminal executes the target behavior in a case that the target multicast service does not support data receiving by a terminal in a non-connected state, where the target behavior includes conversion from a non-connected state to a connected state.

For ease of description, the foregoing two steps are combined for description.

In this embodiment of this application, the first message may carry a multicast service list. Optionally, the first message may be an MCCH message or another common signaling message such as a system information block (System Information Block, SIM) message.

The network side device may indicate, by setting a flag bit for the multicast service list or in the multicast service list, the terminal whether to perform first state conversion. Each multicast service existing in the multicast service list supports data receiving by a terminal in a non-connected state, and a multicast service not existing in the multicast service list does not support data receiving by a terminal in a non-connected state. Alternatively, for each multicast service existing in the multicast service list, if a valid flag bit correspondingly exists in the multicast service, it is considered that the multicast service supports data receiving by a terminal in a non-connected state; or if an invalid flag bit or no valid flag bit correspondingly exists in the multicast service, it is considered that the multicast service does not support data receiving by a terminal in a non-connected state.

After receiving the first message in a non-connected state, the terminal may determine, according to the multicast service list carried in the first message, whether the target multicast service supports data receiving by a terminal in a non-connected state. Optionally, if the multicast service list includes the target multicast service, or the target multicast service included in the multicast service list has a valid flag bit, it may be determined that the target multicast service supports data receiving by a terminal in a non-connected state. If the multicast service list does not include the target multicast service, or the target multicast service included in the multicast service list does not have a valid flag bit, it may be determined that the target multicast service does not support data receiving by a terminal in a non-connected state.

The terminal may convert from a non-connected state to a connected state in a case that the target multicast service does not support data receiving by a terminal in a non-connected state.

By using the multicast service list, the terminal may determine in time whether the target multicast service supports data receiving by a terminal in a non-connected state, and in a case that the target multicast service does not support data receiving by a terminal in a non-connected state, first state conversion is performed in time, to ensure a data receiving effect of the multicast service.

For ease of understanding, the following describes, by using a specific example, a corresponding processing behavior of notifying the terminal to convert to the RRC state and related consideration.

According to a behavior of an R17 terminal, if a service identifier of a target multicast service that the terminal is interested and that has joined appears in a paging message, the terminal immediately makes an RRC state change and enters an RRC connected state. However, in a case that an R18 terminal in an inactive state can already obtain a configuration of the target multicast service, a group paging message is understood as an indication that the target multicast service is in an active state, and does not trigger a state change to enter an RRC connected state.

Therefore, when the network side device actually needs these R18 terminals in an inactive state to return to a connected state to receive multicast service data, for example, a network congestion state is relieved, or service receiving QoS of a terminal cannot satisfy a requirement, a new method is needed to trigger a state change of the terminal. At least one of the following may be considered:
1) A UE specific paging message, where the group paging message mentioned above includes a service identifier TMGI of a multicast service in the paging message, and the UE specific paging message includes a terminal identifier, such as an I-RNTI or a short-temporary mobile subscriber identity (S-Temporary Mobile Subscriber Identity, S-TMSI), in the paging message. Once receiving the UE specific paging message, a terminal should immediately enter a connected state.
2) An explicit indication in an MCCH, similar to the foregoing active/inactive state indication, may also have a dedicated indication field, is located in configuration information corresponding to each TMGI, and indicates whether a corresponding multicast service is valid for a terminal currently in an inactive state, or that a terminal in an inactive state receiving multicast service data should immediately return to a connected state. Once a corresponding indication is read, a terminal immediately triggers a state change to enter a connected state.
3) Further, In addition to a valid or state return indication, an explicit indication in an MCCH may further include restriction information for a returning terminal, for example, setting a scale factor x to a value of 0, 10%, 20%, 30%, . . . , 90%, 100%, or the like. Each value indicates a percentage of terminals that the network side device expects to perform state conversion or continue remaining in an inactive state. For example, if the network side device configures the scale factor to 50%, a terminal behavior is randomly selecting a random value within an interval of [0, 1]. If the random value is less than or equal to 50%, the terminal returns to a connected state; otherwise, the terminal continues to remain in an inactive state; vice versa.
4) An implicit indication in an MCCH, for example, the MCCH originally includes configuration information of a multicast service, when the network side device expects all terminals in an inactive state to return to a connected state to continue receiving data, the network side device may delete configuration information of the multicast service in the MCCH or set the configuration information as invalid information, and when receiving an MCCH message, a terminal immediately trigger a state change to enter a connected state.
5) In addition to an MCCH, a list of multicast services that the network side device currently supports to transmit in an inactive state may also be indicated in other common signaling such as SIB. If a TMGI is removed from the list of multicast services, or a valid flag bit corresponding to the TMGI is removed, it means that the network side device expects all terminals in an inactive state interested in the multicast service to return to a connected state.

When receiving a message used to indicate to perform state conversion from the network side device, a terminal may execute a behavior of converting to a connected state according to the message or additionally according to a scale factor.

The technical solution provided in embodiments of this application is described above from the perspective of notifying a terminal to perform RRC state conversion, and is described below from the perspective of indication of a multicast service end state.

In some embodiments of this application, the method may further include the following step:

The terminal receives a second message from the network side device, where the second message is used to indicate a second service state of the target multicast service or indicate the terminal to perform second state conversion;
where the second service state includes an end state; and
the second state conversion includes conversion from a connected state to a non-connected state or conversion from the inactive state to an idle state.

In this embodiment of this application, the network side device may send a second message to a second terminal, and the second terminal may be a terminal in a connected state, or may be a terminal in a non-connected state. After receiving the first message in a non-connected state, and executing the target behavior according to the first message, the terminal may further receive the second message from the network side device. The terminal herein may be any second terminal.

The second message may include a non-access stratum (Non-Access Stratum, NAS) message or a radio access network (Radio Access Network, RAN) message. The second message is used to indicate a second service state of the target multicast service or indicate the terminal to perform second state conversion. The second service state includes an end state, that is, the network side device may indicate the terminal by using the second message that the target multicast service is in an end state. Alternatively, after the target multicast service is in the end state, if the terminal has no other unicast service, the network side device may indicate the terminal to perform second state conversion, to convert from a connected state to a non-connected state such as an inactive state or an idle state, or indicate the terminal to convert from an inactive state to an idle state, to reduce power consumption of the terminal.

Because the multicast service designs a join (join) process and a leave (leave) process for each terminal, the terminal needs to report, to a core network (Core Network, CN) by using a NAS procedure, that the terminal joins and leaves a receiving group. Therefore, ending of the multicast service also triggers a NAS process, and the core network notifies the terminal of service release (release).

A terminal is usually required to enter a connected state to receive and send NAS signaling in a NAS procedure. For a terminal that receives multicast service data in an inactive state in R18, the terminal may be invoked back to a connected state in the following manner:
1) UE specific paging (UE specific paging): Because downlink NAS signaling is a typical scenario of triggering downlink UE specific paging, when receiving downlink NAS signaling of a terminal, the network side device triggers the terminal to enter a connected state by using a paging message to carry a terminal identifier, for example, an inactive RNTI (Inactive RNTI, I-RNTI). At the same time of ending the NAS procedure, the network side device also releases a related configuration of the target multicast service, for example, an MBS radio bearer (MBS Radio Bearer, MRB) or a data radio bearer (Data Radio Bearer, DRB) accompanying the MRB. Then, the terminal may be released back to a non-connected state, for example, an idle state or an inactive state, based on whether the terminal has another unicast service. In this case, the terminal is an ordinary terminal not interested in the multicast service.
2) an indication for invoking all terminals in a non-connected state to a connected state, for example, in the various manners mentioned in the foregoing embodiments, to make all the currently unconnected terminals return to a connected state. At the same time of ending the NAS procedure, a related configuration of the target multicast service is also released, for example, an MRB, and a DRB accompanying the MRB. Then, the terminal may be released back to a non-connected state such as an idle state or an inactive state according to whether the terminal has another unicast service. In this case, the terminal is an ordinary terminal not interested in the multicast service.

In addition to the existing service ending process notified by the NAS, whether an RAN further needs to make an additional service ending notification or indication may further consider the following:

An end indication or release manner at the RAN side is, for example, indicating an end state of the target multicast service in an explicit or implicit manner in an MCCH or SIB. The explicit manner refers to adding a dedicated indication field to indicate service ending. The implicit manner refers to deleting the target multicast service from the multicast service list, or deleting the configuration information corresponding to the target multicast service, which means ending of the target multicast service. It should be noted that to avoid a conflict, the implicit manner may be used to indicate only one case. For example, one of the implicit manner being used to indicate all terminals to return to a connected state, or the implicit manner being used to indicate service ending is selected, and the other case may be indicated in another manner, to show distinction.

The end indication on the RAN side may be used to release a configuration of the RAN, for example, release a configuration of an MRB related to the target multicast service, or even an accompanying DRB configuration, which may be automatically released. After the release, if still reserving another unicast DRB, the terminal may continue remaining in an inactive state, or otherwise, may return to an idle state. This release manner saves a large amount of release signaling. For example, the release manner may save RRC release signaling on the RAN side, and reduce signaling overheads.

The end indication on the RAN side may be used to release a configuration of the RAN and complete release of the NAS. That is, in addition to resource release on the RAN side in the previous step, information related to the target multicast service on the NAS stratum may also be released, thereby reducing overheads of the RRC release signaling and the NAS signaling when the terminal enters a connected state. However, because the CN/NAS stratum cannot distinguish whether a terminal is in a connected state or an inactive state to receive multicast service data, the release process of the NAS stratum is sent for all joined terminals. If terminals in an inactive state are directly released by the RAN side, the NAS process of these terminals is incomplete, and the RAN side needs to perform some enhancement. For example, the RAN side may reply to the CN, or the CN deals with a failure of the NAS process, or the CN may distinguish different terminal states, and for a terminal that can be released by the RAN side, the NAS release process is not performed.

The technical solution provided in embodiments of this application may enable a terminal to obtain a service state of a multicast service in time when receiving multicast service data in a non-connected state, and continue receiving the multicast service data after starting receiving or stopping receiving correspondingly or performing state conversion according to an indication of a network side device, thereby ensuring timely and normal receiving of the multicast service data by the terminal, and improving terminal experience and system efficiency while ensuring a data receiving effect.

The multicast service processing method provided in the embodiment of this application may be performed by a multicast service processing apparatus. In this embodiment of this application, the multicast service processing apparatus provided in this embodiment of this application is described by using an example in which the multicast service processing apparatus performs the multicast service processing method.

As shown in FIG. 3, a multicast service processing apparatus 300 may include the following modules:
a receiving module 310, configured to receive a first message from a network side device in a non-connected state, where the first message is used to indicate a first service state of a target multicast service or to indicate the terminal whether to perform first state conversion; and
an execution module 320, configured to execute a target behavior according to the first message;
where the first service state includes an active state or an inactive state;
the first state conversion includes conversion from a non-connected state to a connected state; and
the target multicast service is a multicast service that the terminal has joined.

By applying the apparatus provided in this embodiment of this application, a first message is received from a network side device in a non-connected state. The first message is used to indicate a first service state of a target multicast service or indicate the terminal whether to perform first state conversion. The first service state includes an active state or an inactive state. The terminal executes a target behavior according to the first message. A network side device indicates, by using the first message, the first service state of the target multicast service or indicate the terminal whether to perform first state conversion. In this way, related information of the target multicast service can be obtained in time in a non-connected state, and a corresponding behavior is executed in time without the need of the terminal to be always in a connected state to monitor a multicast service and receive multicast service data. Network control and management overheads can be reduced while a receiving effect of the multicast service data is ensured, helping improve overall network efficiency.

In some embodiments of this application, the first message includes a first paging message, the first paging message includes a service identifier of the target multicast service, and the multicast service processing apparatus 300 may further include a determining module. The determining module is configured to:

determine that the first service state of the target multicast service is the active state according to the service identifier of the target multicast service in the first paging message.

In some embodiments of this application, the execution module 320 is configured to:
execute the target behavior according to a capability of the terminal.

In some embodiments of this application, in a case of not having a capability of receiving multicast service data in a non-connected state, the target behavior includes converting from a non-connected state to a connected state.

In some embodiments of this application, the execution module 320 is configured to:
in a case of having a capability of receiving multicast service data in a non-connected state, execute the target behavior if it is determined that valid configuration information of the target multicast service exists, or it is determined that the target multicast service supports data receiving by a terminal in a non-connected state; and the target behavior includes at least one of the following content:
monitoring the target multicast service;
receiving data of the target multicast service; and
remaining in a non-connected state.

In some embodiments of this application, the execution module 320 is configured to:
executing, in a case of having a capability of receiving multicast service data in a non-connected state, the target behavior if it is determined that valid configuration information of the target multicast service does not exist, or it is determined that the target multicast service does not support data receiving by a terminal in a non-connected state, where the target behavior includes converting from a non-connected state to a connected state.

In some embodiments of this application, the first message includes a first multicast control channel message, and the multicast service processing apparatus 300 may further include a determining module. The determining module is configured to:
determine that the first service state of the target multicast service is the active state or the inactive state according to the first multicast control channel message.

In some embodiments of this application, the execution module 320 is configured to:

Execute the target behavior according to the first service state.

In some embodiments of this application, if the target multicast service is in the active state, the target behavior includes monitoring the target multicast service, or receiving data of the target multicast service.

In some embodiments of this application, if the target multicast service is in the inactive state, the target behavior includes stopping monitoring the target multicast service, or stopping receiving data of the target multicast service.

In some embodiments of this application, configuration information corresponding to the target multicast service in the first multicast control channel message includes a first indication field, the first indication field includes a first value or a second value, the first value is used to indicate that the target multicast service is in the active state, and the second value is used to indicate that the target multicast service is in the inactive state.

In some embodiments of this application, the execution module 320 is configured to:
determine, in a case that the configuration information corresponding to the target multicast service in the first multicast control channel message includes the second indication field, that the target multicast service is in a first state, where the first state is the active state or the inactive state; or
determine, in a case that the configuration information corresponding to the target multicast service in the first multicast control channel message does not include the second indication field, that the target multicast service is in a second state, where the second state is the inactive state or the active state; and the first state is different from the second state.

In some embodiments of this application, configuration information corresponding to the target multicast service in the first multicast control channel message includes a third indication field and a fourth indication field, the third indication field is used to indicate whether the target multicast service is in the active state, and the fourth indication field is used to indicate whether the target multicast service is in the inactive state.

In some embodiments of this application, the first message includes a second multicast control channel message, and the execution module 320 is configured to:
determine whether to perform first state conversion according to the second multicast control channel message; and
execute the target behavior in a case that it is determined to perform first state conversion, where the target behavior includes conversion from a non-connected state to a connected state.

In some embodiments of this application, configuration information corresponding to the target multicast service in the second multicast control channel message includes a fifth indication field, and the fifth indication field is used to indicate whether the target multicast service supports data receiving by a terminal in a non-connected state, or indicate whether a terminal in a non-connected state receiving data of the target multicast service is required to enter a connected state.

In some embodiments of this application, the configuration information corresponding to the target multicast service in the second multicast control channel message further includes a sixth indication field, and the sixth indication field is used to indicate restriction information of a terminal returning to a connected state or a terminal remaining in a non-connected state.

In some embodiments of this application, the limitation information includes a scale factor, and the execution module 320 is configured to:

select a random value within a first interval, and determines, according to a magnitude relationship between the random value and the scale factor, whether to perform first state conversion.

In some embodiments of this application, the execution module 320 is configured to:
determine, according to the second multicast control channel message, whether the second multicast control channel message includes configuration information corresponding to the target multicast service or whether included configuration information corresponding to the target multicast service is valid information; and
determine to perform first state conversion in a case that the terminal determines that the second multicast control channel message does not include the configuration information corresponding to the target multicast service or the included configuration information corresponding to the target multicast service is invalid information.

In some embodiments of this application, the first message carries a multicast service list, each multicast service in the multicast service list supports data receiving by a terminal in a non-connected state, or each multicast service having a valid flag bit in the multicast service list supports data receiving by a terminal in a non-connected state, and the execution module 320 is configured to:
determine, according to the multicast service list, whether the target multicast service supports data receiving by a terminal in a non-connected state; and
execute the target behavior in a case that the target multicast service does not support data receiving by a terminal in a non-connected state, where the target behavior includes conversion from a non-connected state to a connected state.

In some embodiments of this application, the receiving module 310 is further configured to:
receive a second message from the network side device, where the second message is used to indicate a second service state of the target multicast service or indicate the terminal to perform second state conversion;
where the second service state includes an end state; and
the second state conversion includes conversion from a connected state to a non-connected state or conversion from the inactive state to an idle state.

In some embodiments of this application, the second message includes a non-access stratum message or a radio access network message.

The multicast service processing apparatus 300 provided in this embodiment of this application can implement the various processes implemented by the method embodiment shown in FIG. 2 and achieve the same technical effects, details of which are omitted here for brevity.

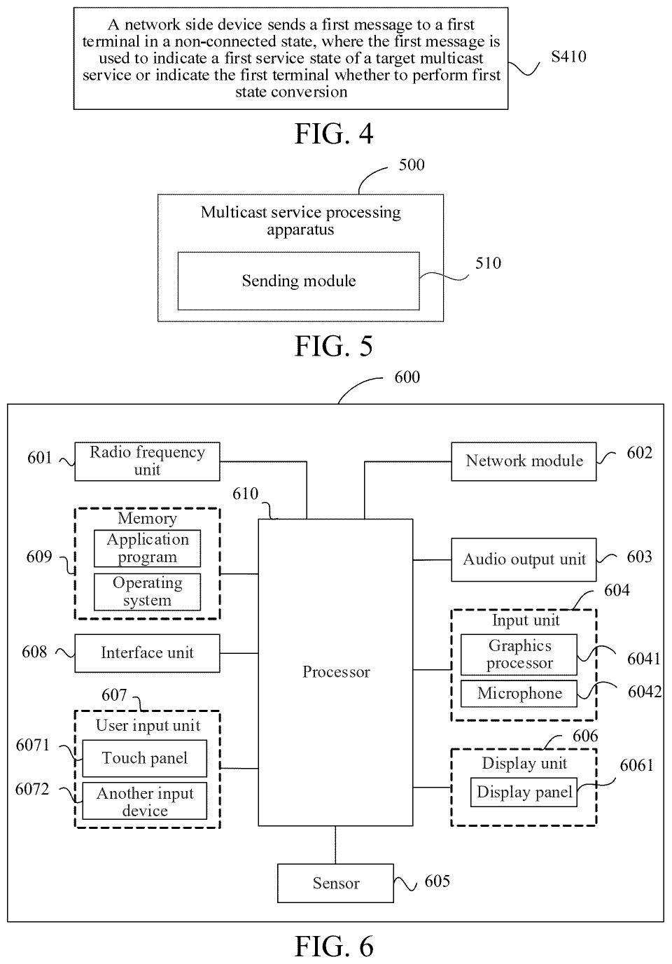

Corresponding to the foregoing method embodiments, an embodiment of this application further provides a multicast service processing method. Referring to FIG. 4, the method may include the following steps:

S410: A network side device sends a first message to a first terminal in a non-connected state, where the first message is used to indicate a first service state of a target multicast service or indicate the first terminal whether to perform first state conversion.

The first service state includes an active state or an inactive state;
the first state conversion includes conversion from a non-connected state to a connected state; and
the target multicast service is a multicast service that the first terminal has joined.

By applying the method provided in this embodiment of this application, the network side device sends the first message to the first terminal in a non-connected state. The first message is used to indicate the first service state of the target multicast service or indicate the first terminal to perform first state conversion. The first service state includes the active state or the inactive state. The network side device indicates, by using the first message, the first service state of the target multicast service or indicate the terminal whether to perform first state conversion. In this way, the terminal can obtain related information of the target multicast service in time in a non-connected state, and execute a corresponding behavior in time without the need of the terminal to be always in a connected state to monitor a multicast service and receive multicast service data. Network control and management overheads can be reduced while a receiving effect of the multicast service data is ensured, helping improve overall network efficiency.

In some embodiments of this application, the first message includes a first paging message, and the first paging message includes a service identifier of the target multicast service.

In some embodiments of this application, the first paging message further includes information used to indicate the first service state of the target multicast service.

In some embodiments of this application, the first message includes a first multicast control channel message, and the first multicast control channel message is used to indicate the first service state of the target multicast service.

In some embodiments of this application, configuration information corresponding to the target multicast service in the first multicast control channel message includes a first indication field, the first indication field includes a first value or a second value, the first value is used to indicate that the target multicast service is in the active state, and the second value is used to indicate that the target multicast service is in the inactive state.

In some embodiments of this application, if configuration information corresponding to the target multicast service in the first multicast control channel message includes a second indication field, the target multicast service is in a first state, where the first state is the active state or the inactive state; or

if configuration information corresponding to the target multicast service in the first multicast control channel message does not include the second indication field, the target multicast service is in a second state, where the second state is the inactive state or the active state; and the first state is different from the second state.

In some embodiments of this application, configuration information corresponding to the target multicast service in the first multicast control channel message includes a third indication field and a fourth indication field, the third indication field is used to indicate whether the target multicast service is in the active state, and the fourth indication field is used to indicate whether the target multicast service is in the inactive state.

In some embodiments of this application, the first message includes a second multicast control channel message, and the second multicast control channel message is used to indicate the first terminal whether to perform first state conversion.

In some embodiments of this application, configuration information corresponding to the target multicast service in the second multicast control channel message includes a fifth indication field, and the fifth indication field is used to indicate whether the target multicast service supports data receiving by a terminal in a non-connected state, or indicate whether a terminal in a non-connected state receiving data of the target multicast service is required to enter a connected state.

In some embodiments of this application, the configuration information corresponding to the target multicast service in the second multicast control channel message further includes a sixth indication field, and the sixth indication field is used to indicate restriction information of a terminal returning to a connected state or a terminal remaining in a non-connected state.

In some embodiments of this application, the limitation information includes a scale factor.

In some embodiments of this application, before the network side device sends the first message to the first terminal in a non-connected state, the method further includes:

The network side device deletes, in a case that the network side device determines to indicate the first terminal to perform first state conversion, configuration information corresponding to the target multicast service from the second multicast control channel message, or set configuration information corresponding to the target multicast service and included in the second multicast control channel message as invalid information.

In some embodiments of this application, the first message carries a multicast service list, each multicast service in the multicast service list supports data receiving by a terminal in a non-connected state, or each multicast service having a valid flag bit in the multicast service list supports data receiving by a terminal in a non-connected state.

In some embodiments of this application, the method further includes:

The network side device sends a second message to a second terminal, where the second message is used to indicate a second service state of the target multicast service or indicate the second terminal to perform second state conversion;
where the second service state includes an end state; and
the second state conversion includes conversion from a connected state to a non-connected state or conversion from the inactive state to an idle state.

In some embodiments of this application, the second message includes a non-access stratum message or a radio access network message.

For a specific implementation process of the method embodiment shown in FIG. 4, references may be made to the specific implementation process description of the method embodiment shown in FIG. 2, which can implement processes implemented in the method embodiment shown in FIG. 2 and achieve the same technical effect. To avoid repetition, details are not described herein again.

The multicast service processing method provided in the embodiment of this application may be performed by a multicast service processing apparatus. In this embodiment of this application, the multicast service processing apparatus provided in this embodiment of this application is described by using an example in which the multicast service processing apparatus performs the multicast service processing method.

As shown in FIG. 5, a multicast service processing apparatus 500 may include the following modules:
a sending module 510, configured to send a first message to a first terminal in a non-connected state, where the first message is used to indicate a first service state of a target multicast service or indicate the first terminal whether to perform first state conversion.

The first service state includes an active state or an inactive state;
the first state conversion includes conversion from a non-connected state to a connected state; and
the target multicast service is a multicast service that the first terminal has joined.

By applying the apparatus provided in this embodiment of this application, the first message is sent to the first terminal in a non-connected state. The first message is used to indicate the first service state of the target multicast service or indicate the first terminal to perform first state conversion. The first service state includes the active state or the inactive state. The first message is used to indicate the first service state of the target multicast service or indicate the terminal whether to perform first state conversion. In this way, the terminal can obtain related information of the target multicast service in time in a non-connected state, and execute a corresponding behavior in time without the need of the terminal to be always in a connected state to monitor a multicast service and receive multicast service data. Network control and management overheads can be reduced while a receiving effect of the multicast service data is ensured, helping improve overall network efficiency.

In some embodiments of this application, the first message includes a first paging message, and the first paging message includes a service identifier of the target multicast service.

In some embodiments of this application, the first paging message further includes information used to indicate the first service state of the target multicast service.

In some embodiments of this application, the first message includes a first multicast control channel message, and the first multicast control channel message is used to indicate the first service state of the target multicast service.

In some embodiments of this application, configuration information corresponding to the target multicast service in the first multicast control channel message includes a first indication field, the first indication field includes a first value or a second value, the first value is used to indicate that the target multicast service is in the active state, and the second value is used to indicate that the target multicast service is in the inactive state.

In some embodiments of this application, if configuration information corresponding to the target multicast service in the first multicast control channel message includes a second indication field, the target multicast service is in a first state, where the first state is the active state or the inactive state; or

if configuration information corresponding to the target multicast service in the first multicast control channel message does not include the second indication field, the target multicast service is in a second state, where the second state is the inactive state or the active state; and the first state is different from the second state.

In some embodiments of this application, configuration information corresponding to the target multicast service in the first multicast control channel message includes a third indication field and a fourth indication field, the third indication field is used to indicate whether the target multicast service is in the active state, and the fourth indication field is used to indicate whether the target multicast service is in the inactive state.

In some embodiments of this application, the first message includes a second multicast control channel message, and the second multicast control channel message is used to indicate the first terminal whether to perform first state conversion.

In some embodiments of this application, configuration information corresponding to the target multicast service in the second multicast control channel message includes a fifth indication field, and the fifth indication field is used to indicate whether the target multicast service supports data receiving by a terminal in a non-connected state, or indicate whether a terminal in a non-connected state receiving data of the target multicast service is required to enter a connected state.

In some embodiments of this application, the configuration information corresponding to the target multicast service in the second multicast control channel message further includes a sixth indication field, and the sixth indication field is used to indicate restriction information of a terminal returning to a connected state or a terminal remaining in a non-connected state.

In some embodiments of this application, the limitation information includes a scale factor.

In some embodiments of this application, the multicast service processing apparatus 500 further includes a processing module, configured to:
before the first message is sent to the first terminal in a non-connected state, delete, in a case that the network side device determines to indicate the first terminal to perform first state conversion, configuration information corresponding to the target multicast service from the second multicast control channel message, or set configuration information corresponding to the target multicast service and included in the second multicast control channel message as invalid information.

In some embodiments of this application, the first message carries a multicast service list, each multicast service in the multicast service list supports data receiving by a terminal in a non-connected state, or each multicast service having a valid flag bit in the multicast service list supports data receiving by a terminal in a non-connected state.

In some embodiments of this application, the sending module 510 is further configured to:
send a second message to a second terminal, where the second message is used to indicate a second service state of the target multicast service or indicate the second terminal to perform second state conversion;
where the second service state includes an end state; and
the second state conversion includes conversion from a connected state to a non-connected state or conversion from the inactive state to an idle state.

In some embodiments of this application, the second message includes a non-access stratum message or a radio access network message.

The multicast service processing apparatus 500 provided in this embodiment of this application can implement the various processes implemented by the method embodiment shown in FIG. 4 and achieve the same technical effects, details of which are omitted here for brevity.

An embodiment of this application further provides a terminal. As shown in FIG. 6, the terminal 600 includes but is not limited to: at least some of components such as a radio frequency unit 601, a network module 602, an audio output unit 603, an input unit 604, a sensor 605, a display unit 606, a user input unit 607, an interface unit 608, a memory 609, and a processor 610.

A person skilled in the art may understand that the terminal 600 may further include a power supply (for example, a battery) that supplies power to each component. The power supply may be logically connected to the processor 610 by using a power management system, so as to manage functions such as charging, discharging, and power consumption by using the power management system. The terminal structure shown in FIG. 6 constitutes no limitation on the terminal, and the terminal may include more or fewer components than those shown in the figure, or combine some components, or have different component arrangements.

It should be understood that, in this embodiment of this application, the input unit 604 may include a graphics processing unit (Graphics Processing Unit, GPU) 6041 and a microphone 6042. The graphics processing unit 6041 processes image data of a still picture or a video obtained by an image capture apparatus (such as a camera) in a video capture mode or an image capture mode. The display unit 606 may include a display panel 6061. The display panel 6061 may be configured in a form such as a liquid crystal display or an organic light-emitting diode. The user input unit 607 may include at least one of a touch panel 6071 and another input device 6072. The touch panel 6071 is also referred to as a touchscreen. The touch panel 6071 may include two parts: a touch detection apparatus and a touch controller. The another input device 6072 may include but is not limited to a physical keyboard, a function key (such as a volume control key or an on/off key), a trackball, a mouse, and a joystick. Details are not described herein.

In this embodiment of this application, after receiving downlink data from a network side device, the radio frequency unit 601 may transmit the downlink data to the processor 610 for processing. In addition, the radio frequency unit 601 may send uplink data to the network side device. Generally, the radio frequency unit 601 includes but is not limited to: an antenna, an amplifier, a transceiver, a coupler, a low noise amplifier, a duplexer, and the like.

The memory 609 may be configured to store a software program, instructions, and various data. The memory 609 may mainly include a first storage area for storing a program or instructions and a second storage area for storing data, where the first storage area may store an operating system, an application program or instructions (such as a sound playback function or an image playback function) required by at least one function, and the like. In addition, the memory 609 may include a volatile memory or a non-volatile memory, or the memory 609 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus random access memory (Direct Rambus RAM, DRRAM). The memory 609 in this embodiment of this application includes but is not limited to these and any other suitable type of memory.

The processor 610 may include one or more processing units. Optionally, the processor 610 integrates an application processor and a modem processor, where the application processor mainly processes operations related to an operating system, a user interface, an application program, and the like, and the modem processor mainly processes a wireless communication signal, such as a baseband processor. It may be understood that the modem processor may not be integrated into the processor 610.

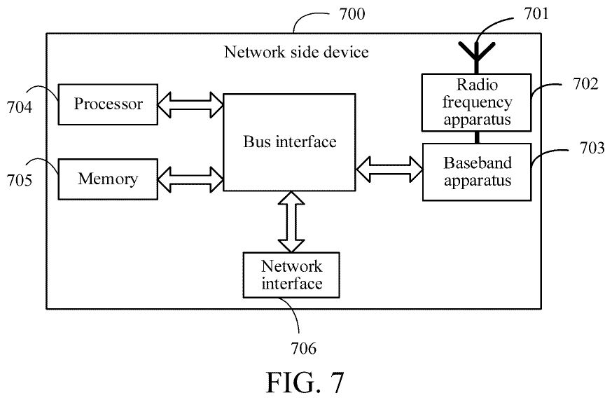

An embodiment of this application further provides a network side device. As shown in FIG. 7, the network side device 700 includes an antenna 701, a radio frequency apparatus 702, a baseband apparatus 703, a processor 704, and a memory 705. The antenna 701 is connected to the radio frequency device 702. In an uplink direction, the radio frequency apparatus 702 receives information through the antenna 701, and sends the received information to the baseband apparatus 703 for processing. In a downlink direction, the baseband apparatus 703 processes information to be sent and sends the information to the radio frequency apparatus 702, and the radio frequency apparatus 702 processes the received information and sends the information through the antenna 701.

The method performed by the network side device in the foregoing embodiment may be implemented in the baseband apparatus 703, and the baseband apparatus 703 includes a baseband processor.

The baseband apparatus 703 may include, for example, at least one baseband board. A plurality of chips are disposed on the baseband board. One chip is, for example, the baseband processor, and is connected to the memory 705 through a bus interface, to call a program in the memory 705 to perform the operations of the network side device shown in the foregoing method embodiment.

The network side device may further include a network interface 706. The interface is, for example, a common public radio interface (CPRI).

Specifically, the network side device 700 in this embodiment of this application further includes instructions or a program stored in the memory 705 and capable of running on the processor 704. The processor 704 invokes the instructions or the program in the memory 705 to perform the method performed by the modules shown in FIG. 5, and a same technical effect can be achieved. To avoid repetition, details are not described herein again.

The embodiments of this application further provide a readable storage medium. The readable storage medium stores programs or instructions. The programs or instructions, when executed by a processor, implement the various processes of the above method embodiments shown in FIG. 2 or FIG. 4 and can achieve the same technical effects, details of which are omitted here for brevity.

The processor is the processor in the terminal in the foregoing embodiment. The readable storage medium includes a computer-readable storage medium such as a computer read-only memory ROM, a random access memory RAM, a magnetic disk, or an optical disc.

The embodiments of this application further provide a computer program/program product. The computer program/program product is stored in a storage medium. The computer program/program product, when executed by at least one processor, implements the various processes of the above method embodiment of FIG. 2 or FIG. 4, and can achieve the same technical effects, details of which are omitted here for brevity.

An embodiment of this application further provides a communication system, including: a terminal and a network side device, where the terminal may be configured to perform the steps of the method embodiment shown in FIG. 2, and the network side device may be configured to perform the steps of the method embodiment shown in FIG. 4.

It should be noted that the terms “include”, “comprise”, or any other variations thereof in this specification are intended to cover a non-exclusive inclusion, such that a process, method, article, or apparatus including a series of elements not only includes those elements, but also includes other elements that are not explicitly listed, or also includes elements inherent to such process, method, article, or apparatus. Without more limitations, elements defined by the sentence “including one” does not exclude that there are still other same elements in the processes, methods, objects, or apparatuses that include the elements. In addition, it should be noted that the scope of the method and apparatus in the embodiments of this application is not limited to performing a function in a sequence shown or discussed, and may further include performing a function in a basically simultaneous manner or in a reverse sequence based on a related function. For example, the described method may be performed in an order different from the described order, and various steps may be added, omitted, or combined. In addition, features described with reference to some examples may be combined in other examples.

Based on the descriptions in the foregoing implementations, a person skilled in the art may clearly learn that the method in the foregoing embodiment may be implemented by software in addition to a necessary universal hardware platform or by hardware. In most circumstances, the former is a better implementation. Based on such an understanding, the technical solutions of this application essentially, or the part contributing to the prior art, may be presented in the form of a computer software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. The foregoing specific implementations are merely examples, and are not restrictive. Under the enlightenment of this application, many forms may be further made by a person of ordinary skill in the art without departing from the objective of this application and the protection scope of the claims and shall fall within the protection scope of this application.

What is claimed is:

1. A multicast service processing method, comprising:
receiving, by a terminal in a non-connected state, a first message from a network side device, wherein the first message is used to indicate a first service state of a target multicast service or to indicate the terminal whether to perform first state conversion; and
executing, by the terminal, a target behavior according to the first message;
wherein the first service state comprises an active state or an inactive state;
the first state conversion comprises conversion from a non-connected state to a connected state; and
the target multicast service is a multicast service that the terminal has joined.

2. The method according to claim 1, wherein the first message comprises a first paging message, the first paging message comprises a service identifier of the target multicast service, and the method further comprises:
determining, by the terminal, that the first service state of the target multicast service is the active state according to the service identifier of the target multicast service in the first paging message.

3. The method according to claim 1, wherein the executing, by the terminal, a target behavior according to the first message comprises:
executing, by the terminal, the target behavior according to a capability of the terminal.

4. The method according to claim 3, wherein the terminal does not have a capability of receiving multicast service data in a non-connected state, and the target behavior comprises converting from a non-connected state to a connected state.

5. The method according to claim 3, wherein the executing, by the terminal, the target behavior according to a capability of the terminal comprises:
executing, by the terminal in a case that the terminal has a capability of receiving multicast service data in a non-connected state, the target behavior if it is determined that the terminal has valid configuration information of the target multicast service, or it is determined that the target multicast service supports data receiving by a terminal in a non-connected state; and
the target behavior comprises at least one of the following content:
monitoring the target multicast service;
receiving data of the target multicast service; and
remaining in a non-connected state.

6. The method according to claim 3, wherein the executing, by the terminal, the target behavior according to a capability of the terminal comprises:
executing, by the terminal in a case that the terminal has a capability of receiving multicast service data in a non-connected state, the target behavior if it is determined that the terminal does not have valid configuration information of the target multicast service, or it is determined that the target multicast service does not support data receiving by a terminal in a non-connected state, wherein the target behavior comprises converting from a non-connected state to a connected state.

7. The method according to claim 1, wherein the first message comprises a first multicast control channel message, and the method further comprises:
determining, by the terminal, that the first service state of the target multicast service is the active state or the inactive state according to the first multicast control channel message.

8. The method according to claim 2, wherein the executing, by the terminal, a target behavior according to the first message comprises:
executing, by the terminal, the target behavior according to the first service state.

9. The method according to claim 8, wherein if the target multicast service is in the inactive state, the target behavior comprises stopping monitoring the target multicast service, or stopping receiving data of the target multicast service.

10. The method according to claim 8, wherein configuration information corresponding to the target multicast service in the first multicast control channel message comprises a first indication field, the first indication field comprises a first value or a second value, the first value is used to indicate that the target multicast service is in the active state, and the second value is used to indicate that the target multicast service is in the inactive state.

11. The method according to claim 8, wherein the determining, by the terminal, that the first service state of the target multicast service is the active state or the inactive state according to the first multicast control channel message comprises:
determining, by the terminal in a case that the configuration information corresponding to the target multicast service in the first multicast control channel message comprises a second indication field, that the target multicast service is in a first state, wherein the first state is the active state or the inactive state; or
determining, by the terminal in a case that the configuration information corresponding to the target multicast service in the first multicast control channel message does not comprise the second indication field, that the target multicast service is in a second state, wherein the second state is the inactive state or the active state; and
the first state is different from the second state.

12. A multicast service processing method, comprising:
sending, by a network side device, a first message to a first terminal in a non-connected state, wherein the first message is used to indicate a first service state of a target multicast service or indicate the first terminal whether to perform first state conversion;
wherein the first service state comprises an active state or an inactive state;
the first state conversion comprises conversion from a non-connected state to a connected state; and
the target multicast service is a multicast service that the first terminal has joined.

13. The method according to claim 12, wherein the first message comprises a first paging message, and the first paging message comprises a service identifier of the target multicast service.

14. The method according to claim 13, wherein the first paging message further comprises information used to indicate the first service state of the target multicast service.

15. The method according to claim 12, wherein the first message comprises a first multicast control channel message, and the first multicast control channel message is used to indicate the first service state of the target multicast service.

16. The method according to claim 15, wherein configuration information corresponding to the target multicast service in the first multicast control channel message comprises a first indication field, the first indication field comprises a first value or a second value, the first value is used to indicate that the target multicast service is in the active state, and the second value is used to indicate that the target multicast service is in the inactive state.

17. The method according to claim 15, wherein if configuration information corresponding to the target multicast service in the first multicast control channel message comprises a second indication field, the target multicast service is in a first state, wherein the first state is the active state or the inactive state; or
if configuration information corresponding to the target multicast service in the first multicast control channel message does not comprise the second indication field, the target multicast service is in a second state, wherein the second state is the inactive state or the active state; and
the first state is different from the second state.

18. A terminal, comprising a processor and a memory, wherein the memory stores a program or instructions capable of running on the processor, and the program or the instructions are executed by the processor to implement a multicast service processing method, the multicast service processing method comprising:
receiving, by a terminal in a non-connected state, a first message from a network side device, wherein the first message is used to indicate a first service state of a target multicast service or to indicate the terminal whether to perform first state conversion; and
executing, by the terminal, a target behavior according to the first message;
wherein the first service state comprises an active state or an inactive state;
the first state conversion comprises conversion from a non-connected state to a connected state; and
the target multicast service is a multicast service that the terminal has joined.

19. A network side device, comprising a processor and a memory, wherein the memory stores a program or instructions capable of running on the processor, and the program or the instructions are executed by the processor to implement the multicast service processing method according to claim 12.

20. A non-transitory readable storage medium, wherein a program or instructions are stored on the readable storage medium, and the program or the instructions are executed by a processor to implement the multicast service processing method according to claim 1.
